(19) United States
(12) Patent Application Publication
(10) Pub. No.: US 2023/0124443 A1
(43) Pub. Date: Apr. 20, 2023

(54) TONE ARM AND RECORD PLAYER

(71) Applicant: Ogasawara Precision Laboratory Co., Ltd., Kanagawa (JP)

(72) Inventor: Hiroomi Ogasawara, Iwate (JP)

(73) Assignee: Ogasawara Precision Laboratory Co., Ltd., Kanagawa (JP)

(21) Appl. No.: 18/069,972

(22) Filed: Dec. 21, 2022

Related U.S. Application Data
(63) Continuation of application No. PCT/JP2020/046591, filed on Dec. 14, 2020.

(30) Foreign Application Priority Data
Jun. 22, 2020 (JP) 2020-107166

(51) Int. Cl. G11B 3/085; G11B 3/12

(52) U.S. Cl. CPC G11B 3/08506; G11B 3/125

(57) ABSTRACT

A tone arm according to an embodiment includes: a first arm configured to rotate around a rotation shaft in a horizontal direction of a record; a second arm configured to rotate around a free fulcrum of the first arm as the first arm rotates; a motor configured to rotatably drive the first arm; and a controller configured to control a phase angle of the motor so that the second arm is disposed with a longitudinal axis thereof extends in a tangent direction of a groove of the record at a contact position of a stylus attached to a tip portion of the second arm and the groove of the record.

### CROSS REFERENCE TO RELATED APPLICATIONS

This application is a Continuation of International Application no. PCT/JP2020/046591, filed Dec. 14, 2020, which claims priority to Japanese Patent Application No. 2020-107166, filed on Jun. 22, 2020, the entire disclosures of which are hereby incorporated herein by reference.

### FIELD

The disclosure herein relates to a tone arm and a record player for causing a stylus to be in contact with a groove of a record.

### BACKGROUND

When a record is played, an energy conversion mechanism for converting mechanical changes to electrical signals is needed, which detects information on changes in sound groove as electrical changes. A device for such conversion is called “phono cartridge.”

Information included in a record is stored in such a manner that changes in a normal direction relative to the rotating surface of the record are recorded as acoustic signals. The electric information, such as music, obtained from the record is therefore velocity signals obtained as changes in amplitude of the groove per a unit time.

A stylus of a phono cartridge is always in frictional contact with a groove (also called as “sound groove”) of a record along the amplitude of the groove. Since the record is a disc, the stylus traces the spiral sound groove toward the rotation center of the record.

When the record is played, ideally the stylus is linearly moved in the radius direction of the record, as in a machine for cutting the groove (cutting lathe). However, a typical record player includes a tone arm, to a tip portion of which a phono cartridge is attached, and the stylus is moved along the groove of the record by rotating a rotation shaft disposed at a rear end of the tone arm, thereby reproducing the sound of the record.

FIG. 8 shows a phono cartridge 32 attached to a tip portion of a tone arm 31 having the aforementioned structure. As shown in FIG. 8, at an outer portion and an inner portion of a predetermined radius of the record, the moving direction of the stylus and the groove of the record do not make the right angle. The difference from the right angle is generally called “tracking angle error”, as described in JP S51-117003 A.

In order to minimize the tracking angle error, a structure in which a phono cartridge 34 is disposed to a tone arm 33 to have an angle, as shown in FIG. 9, is widely used. The angle of the phono cartridge 34 relative to the tone arm is called “tracking angle.” However, the tracking angle error is not always eliminated in this method.

Although the tracking angle may reduce the tracking angle error, an inside force, which is a force for drawing the phono cartridge 34 toward the inside of the record, may be generated. Since the stylus is elastically supported in the amplitude direction of the sound groove, a pull force (trace force) is caused to the phono cartridge 34 by the friction that is generated when the stylus moves along the sound groove in the circumferential direction. This force acts as a couple in the direction that is offset by the aforementioned tracking angle from the rotation shaft center of the tone arm 33. A part of the components of the force acts as a rotational force of the tone arm. A component of the pull force drawing the tone arm toward the center of the record is called “inside force.”

As described above, the inside force is a component force that draws the stylus toward the center of the turn table when the record is rotated and the stylus of the phono cartridge contacts the groove of the record.

As shown in FIG. 10, a component force F₁ of a pull force (trace force) F generated by the friction caused by the movement of the stylus along the circumferential direction of the sound groove is counterbalanced with a tensile force F₃ toward the center of the rotation of the arm. A component force F₂, however, draws the stylus in the direction of the rotation of the arm or toward the center of the turn table. In the art of analog record players, this component force F₂ is generally called “inside force.” The stylus is pulled by the inside force in a direction that is different from the radius direction of the groove. The harmful influence of the inside force on the sound quality has long been pointed out in the record player industry. It is said that the inside force impairs the balance of may be impaired. There may be other inconveniences caused by the inside force, such as distortion of sound.

Generally, a mechanism called “inside force canceller” is disposed to most tone arms in order to prevent the inside force. However, the inside force canceller is a mechanism for pulling the tone arm in the direction opposite to the direction of the component force F₂ using a weight, a spring, or a magnetic force, for example. Thus, the inside force canceller is not a mechanism for preventing the generation of the inside force.

Some other tone arm mechanisms are proposed and commercialized, which are intended to avoid or reduce the inside force. A typical example, which is also theoretically right example, is a mechanism using a linear tracking method as shown in FIG. 11.

A support 36a of a tone arm 36 supporting a phono cartridge 35 is moved along a linear guide 37 with the tone arm 36 being freely moved in the vertical direction, so that a stylus of the phono cartridge 35 is moved toward the center of a turn table. If a slide guide or a rolling guide is used as the linear guide 37 for sliding the tone arm 36, a problem of frictional resistance may be caused. In order to solve this problem, products using aerostatic bearings, which have no frictional resistance, are commercialized as an ultimate solving method. However, such products have complicated structures and are very expensive. Furthermore, such products additionally require a compressed air supplier, which needs maintenance. Therefore, it is not practical from the viewpoint of maintenance and costs to use such products in the tone arm 36.

Another example for reducing the inside force is a parallel link structure (in which the position of a phono cartridge is kept in the normal direction of a sound groove by changing an offset angle using two arms disposed in parallel to each other). This structure, however, cannot prevent the occurrence of inside force, either.

Several proposals including the aforementioned examples have been tried to curb the tracking angle error and the inside force. However, in practice, very few mechanisms are widely used and evaluated except for inside force cancellers that may only reduce inside force a little.

An aspect of the present disclosure proposes a tone arm and a record player having a simple structure but reducing both the tracking angle error and the inside force.

In order to solve the aforementioned problem, a tone arm according to an aspect of the present disclosure includes:

a first arm configured to rotate around a rotation shaft in a horizontal direction of a record;

a second arm configured to rotate around a free fulcrum of the first arm as the first arm rotates;

a motor configured to rotatably drive the first arm; and

a controller configured to control a phase angle of the motor so that the second arm is disposed with a longitudinal axis thereof extends in a tangent direction of a groove of the record at a contact position of a stylus attached to a tip portion of the second arm and the groove of the record.

The second arm may include a joint mechanism rotatably attached to the free fulcrum, the joint mechanism rotating in accordance with a rotation of the first arm and a movement of the stylus along the groove of the record.

The controller may control the phase angle of the motor so that a direction of a line segment connecting the contact position of the second arm and the free fulcrum is in parallel to the tangent direction of the groove while the record is being played.

The controller may control the phase angle of the motor so that no inside force or tracking angle error is generated at the contact position.

The tone arm may further include a first angle detector configured to detect an angle of rotation of the first arm and a second angle detector configured to detect an angle of rotation of the second arm,

wherein the controller may regulate the angle of rotation of the first arm by controlling the phase angle of the motor so that the longitudinal axis of the second arm is in the tangent direction of the groove at the contact position based on the angle of rotation of the first arm detected by the first angle detector and the angle of rotation of the second arm detected by the second angle detector.

The controller may control the phase angle of the motor so that the angle of rotation of the second arm detected by the second angle detector matches an angle of rotation calculated based on the angle of rotation of the first arm detected by the first angle detector, a distance from a rotation center of the turn table for rotating the record to the rotation shaft of the first arm, a distance from a rotation center of the turn table to the free fulcrum, a length of the first arm, and a length of the second arm.

The first arm and the second arm may be disposed so that a line segment connecting the contact position and the free fulcrum does not cross a line segment connecting a rotation center of the turn table and the rotation shaft of the first arm

The first arm and the second arm may be disposed so that a line segment connecting the contact position and the free fulcrum crosses a line segment connecting a rotation center of the turn table and the rotation shaft of the first arm.

A record player according to another aspect of the present disclosure includes:

a turn table configured to rotate a record; and

a tone arm configured to cause a stylus to be in contact with a groove of the record rotating on the turn table,

wherein the tone arm includes:

a first arm configured to rotate around a rotation shaft in a horizontal direction of the record;

a second arm configured to rotate around a free fulcrum of the first arm as the first arm rotates;

a stylus that is attached to a tip portion of the second arm and in contact with a groove of the record;

a motor configured to rotatably drive the first arm; and

a controller configured to control a phase angle of the motor so that the second arm is disposed with a longitudinal axis thereof extending in a tangent direction of the groove of the record at a contact position of the stylus and the groove of the record while the record is being played.

### Effects of the Invention

### BRIEF DESCRIPTION OF THE DRAWINGS

FIG. 1 is an external view of a record player 2 including a tone arm 1 according to an embodiment.

FIG. 2 is a plan view around the tone arm 1.

FIG. 3 is a block diagram of a control system of the tone arm 1.

FIG. 4 is a diagram showing a geometric arrangement of a control arm 1a and a pickup arm 1b.

FIG. 5 is a diagram showing changes in angle of rotation φ of the pickup arm 1b as the angle of rotation θ of the control arm 1a is changed in various ways.

FIG. 6 is a diagram showing a geometric arrangement of the tone arm 1 when the control arm 1a and the pickup arm 1b are arranged so that a line segment OS crosses the pickup arm 1b.

FIG. 7 is a diagram showing changes in angle of rotation φ of the pickup arm 1b as the angle of rotation θ of the control arm 1a is changed in various ways.

FIG. 8 is a diagram for explaining tracking angle error.

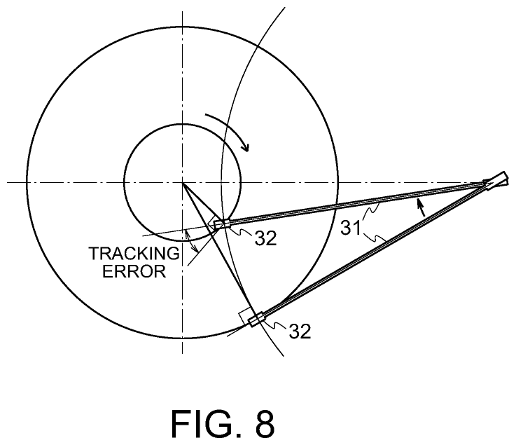

FIG. 9 shows an example of a tone arm having a minimized tracking angle error.

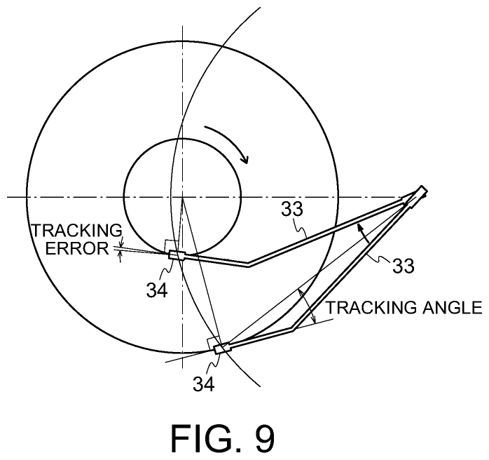

FIG. 10 is a diagram for explaining inside force.

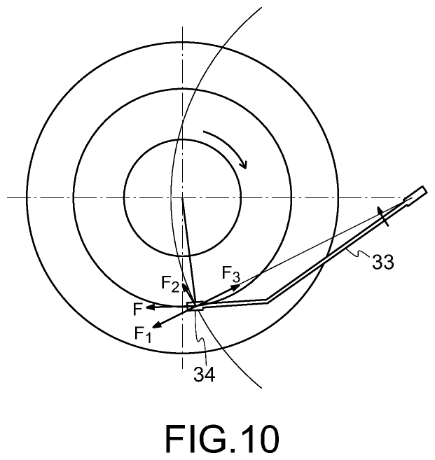

FIG. 11 is a diagram for explaining a linear tracking method.

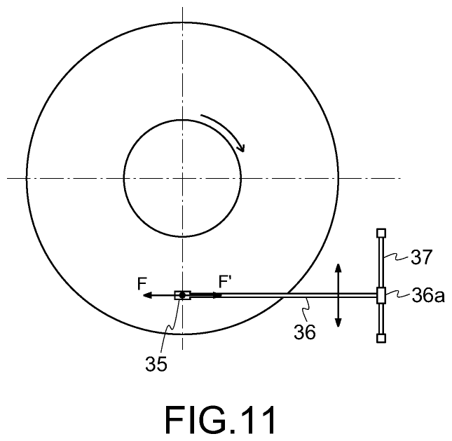

### S

An embodiment of a tone arm and a record player will be described below with reference to the accompanying drawings. Although main components of the embodiment will be mainly described below, components and/or functions that are not illustrated or explained may also be present. The descriptions given below will not exclude additional components or functions that are not illustrated or explained.

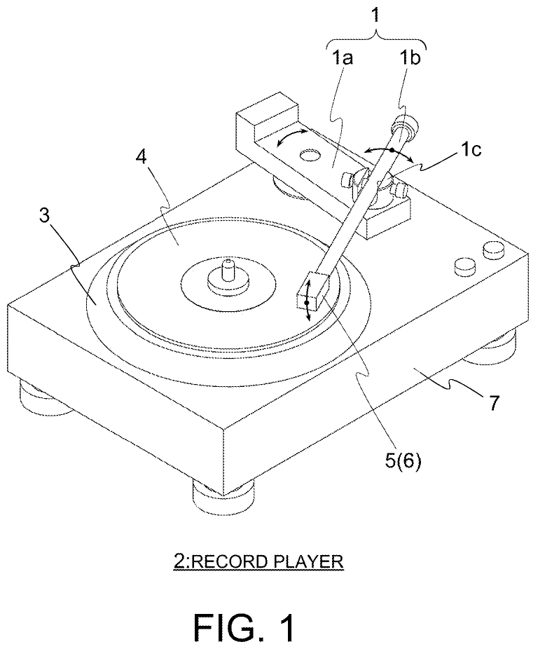

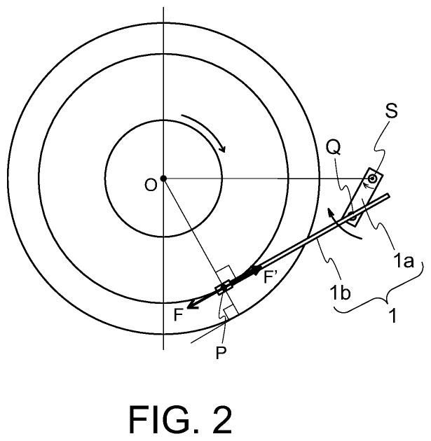

FIG. 1 is an external view of a record player 2 including a tone arm 1 according to the embodiment, and FIG. 2 is a plan view around the tone arm 1.

As shown in FIGS. 1 and 2, the record player 2 includes the tone arm 1 and a turn table 3. The turn table 3 rotates a record 4 placed on the turn table 3 around a rotation axis at the center of the turn table 3. A stylus 5 is attached to a tip portion of the tone arm 1. The tone arm 1 causes the stylus 5 to be in contact with a groove of the record 4 rotating on the turn table 3. The stylus 5 is fixed to a phono cartridge 6 that is removably attached to the tone arm 1. A rotation mechanism of the turn table 3 and a rotation mechanism of the tone arm 1 are housed in a housing 7 of the record player 2. A power supply unit and a motor driver are also housed in the housing 7.

The tone arm 1 according to the embodiment includes a control arm (first arm) 1a and a pickup arm (second arm) 1b. The control arm 1a is disposed on a rear side of the tone arm 1, and the pickup arm 1b is disposed on a front side of the tone arm 1.

The control arm 1a rotates around a rotation shaft in a horizontal direction of the record 4. The rotation shaft of the control arm 1a is located near a rear end of the tone arm 1. As will be described later, the control arm is driven to rotate by a motor. The control arm 1a is rotated in the horizontal direction in accordance with the rotation direction and the rotation speed of the rotation shaft. A sensor for constantly detecting the angle of rotation of the rotation shaft, for example a rotary encoder, is disposed to the rotation shaft of the control arm 1a. The sensor may also be called “first angle detector” herein.

A free fulcrum Q is provided at an end of the control arm 1a opposite to the rear end, for rotatably supporting the pickup arm 1b. A joint mechanism 1c is disposed to the free fulcrum Q for supporting the pickup arm 1b so as to freely rotate in the horizontal direction of the record 4. The joint mechanism 1c includes a rotation shaft for rotating the pickup arm 1b in the horizontal direction, and a sensor (for example, a rotary encoder) for reading the angle of rotation of the rotation shaft. The sensor is capable of constantly detecting the angle of rotation of the pickup arm 1b. This sensor may also be called “second angle detector” herein. The joint mechanism 1c rotates the pickup arm 1b in accordance with the rotation of the control arm 1a and the movement of the stylus 5 along the groove of the record 4.

The pickup arm 1b rotates around the free fulcrum Q of the control arm 1a in accordance with the rotation of the control arm 1a. The free fulcrum Q is located on the rear side of the pickup arm 1b. The phono cartridge 6 with the stylus 5 is attached to the tip side of the pickup arm 1b. The pickup arm 1b rotates in the horizontal direction of the record 4 in sync with the rotation of the control arm 1a, with the stylus 5 being in contact with the groove of the record 4.

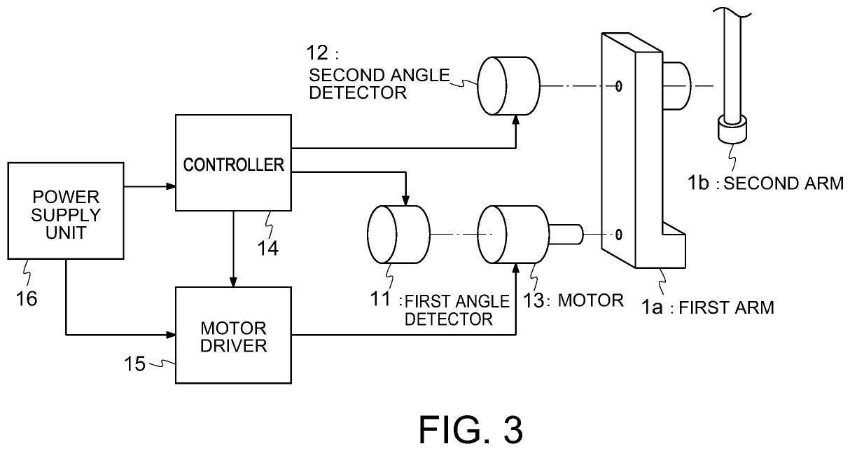

FIG. 3 is a block diagram of a control system of the tone arm 1. As shown in FIG. 3, the tone arm 1 includes a first angle detector 11, a second angle detector 12, a motor 13, a controller 14, a motor driver 15, and a power supply unit 16. The control system of the tone arm 1 is housed in, for example, the housing 7 that supports the turn table 3 in FIG. 1.

The first angle detector 11 detects the angle of rotation of the control arm 1a. As described above, the first angle detector 11 includes, for example, a rotary encoder. The second angle detector 12 detects the angle of rotation of the pickup arm 1b. As described above, the second angle detector 12 includes a rotary encoder, for example. The motor 13 drives the control arm 1a to rotate. The motor 13 drives the control arm 1a so that the angle of rotation of the control arm 1a is at a desired value. The motor 13 is driven and controlled by the motor driver 15. The controller 14 sends a command signal to the motor driver 15 to cause the angle of rotation of the control arm 1a to be at a desired value. The motor driver 15 controls and drives the motor 13 according to the command signal.

The controller 14 controls the phase angle of the motor 13 so that the longitudinal axis of the pickup arm 1b is in the tangent direction of the groove at the contact position between the groove of the record 4 and the stylus 5 while the record 4 is being played. In other words, the controller 14 controls the phase angle of the motor 13 so that a line segment connecting the contact position P of the pickup arm 1b and the free fulcrum Q is in parallel with the tangent direction of the groove while the record 4 is being played. The controller 14 includes, for example, a central processing unit (CPU).

The controller 14 adjusts the phase angle of the motor 13 so that no inside force and no tracking angle error is generated at the contact position of the stylus 5 and the groove of the record 4. By adjusting the phase angle of the motor 13, the controller 14 also controls the angle of rotation of the control arm 1a around the rotation shaft in a first reference direction, and the controls the angle of rotation of the pickup arm 1b around the free fulcrum Q in a second reference direction. Furthermore, the controller 14 adjusts the angle of rotation of the control arm 1a by controlling the phase angle of the motor 13 so that the longitudinal axis of the pickup arm 1b is in the tangent direction of the groove at the contact position P based on the angle of rotation of the control arm 1a detected by the first angle detector 11 and the angle of rotation of the pickup arm 1b detected by the second angle detector 12.

More specifically, the controller 14 controls the phase angle of the motor 13 so that the angle of rotation of the pickup arm 1b detected by the second angle detector 12 is equal to an angle of rotation calculated based on the angle of rotation of the control arm 1a detected by the first angle detector 11, the distance from the rotational center of the turn table 3 that rotates the record 4 to the rotation shaft S of the control arm 1a, the distance from the rotation center O of the turn table 3 to the free fulcrum Q, the length of the control arm 1a, and the length of the pickup arm 1b.

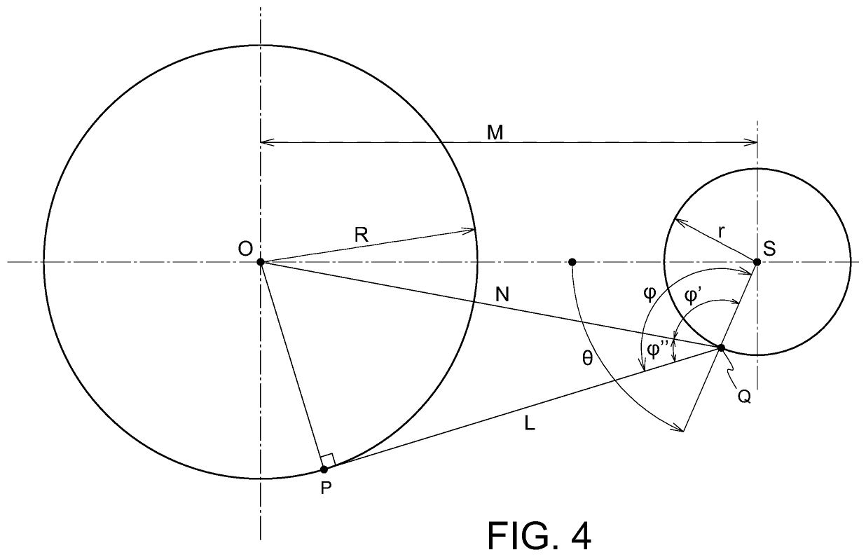

FIG. 4 is a diagram showing a geometric arrangement of the control arm 1a and the pickup arm 1b. In FIG. 4, the rotation center of the turn table 3 is denoted as O, the contact position of the stylus 5 and the groove of the record 4 is denoted as P, the rotation axis at the free fulcrum Q of the pickup arm 1b is denoted as Q, the radius of the groove of the record 4 is denoted as R, the radius of the rotation of the control arm 1a is denoted as r, which is indicated by a line segment QS, the rotation shaft of the pickup arm 1b is denoted as S, the distance between the rotation center O of the turn table 3 and the rotation shaft S of the control arm 1a is denoted as M, which is indicated by a line segment OS, and the distance between the contact position P and the rotation axis Q is denoted as L, which is indicated by a line segment PQ. Furthermore, in FIG. 4, the angle of rotation of the control arm 1a with respect to the line segment OS connecting the rotation center O of the turn table 3 and the rotation shaft S is denoted as O, and the angle of rotation of the pickup arm 1b with respect to the longitudinal axis of the control arm 1a, which is the angle between the control arm 1a and the pickup arm 1b, is denoted as φ.

The controller 14 sends a command to set a target rotation angle of the control arm 1a to the motor 13 so that the angle ∠OPQ formed by the line segment OP between the rotation center O and the contact position P and the line segment PQ between the contact position P and the rotation axis Q is 90 degrees, based on the value of the angle of rotation at the rotation axis Q of the pickup arm 1b detected by the second angle detector 12. In other words, the controller 14 sends a command to set the target rotation angle of the control arm 1a to the motor 13 so that the line segment PQ may be a tangent to the record 4 at the contact position P. Always making the right angle between the line segment OP and the line segment PQ while the record 4 is being played means that the stylus 5 may be moved in the tangent direction of the groove of the record 4.

If the angle between the line segment OP and the line segment PQ is controlled to be always the right angle while the record 4 is being played, the frictional force F applied to the stylus 5 is cancelled by the tensile strength F′ applied to the pickup arm 1b, as shown in FIG. 2. As a result, no inside force is generated. Furthermore, since the stylus 5 always moves in the tangent direction of the groove of the record 4, no tracking angle error is caused.

The geometrical relationship among the contact position P of the stylus 5 and the groove of the record 4, the angle of rotation θ of the control arm 1a, and the angle of rotation φ of the pickup arm 1b will then be described with reference to FIG. 4. In the embodiment, the distance M from the rotation center O of the turn table 3 to the rotation shaft S of the tone arm 1 indicated by the line segment OS and the length L of the pickup arm 1b indicated by the line segment PQ, and the distance r from the rotation shaft S of the control arm 1a to the rotation axis Q of the pickup arm 1b indicated by the segment line SQ have predetermined fixed values (design parameters). The radius R of the groove of the record 4 changes as the playing position of the record 4 changes, and may generally be approximately 60 mm<R<150 mm.

The following equation (1) holds, in which N is the length of a line segment OQ connecting the rotation center O of the turn table 3 and the rotation axis Q of the pickup arm 1b.

N=\sqrt{L²+R²} (1)

With respect to ΔOSQ, the following equations (2) hold from the cosine law of the trigonometry.

$$θ = ∠ O S Q = {cos}^{- 1} \frac{{M}^{2} + {r}^{2} - {N}^{2}}{2 M r} \qquad ( 2 )$$

With respect to ΔSQO, φ′=∠SQO may be obtained from the equations (3) from the cosine law, and φ″=∠OQP is obtained from the equations (4).

$${φ}^{′} = ∠ SQO = π - θ - {cos}^{- 1} \frac{{M}^{2} + {N}^{2} - {r}^{2}}{2 M N} \qquad ( 3 )$$

$${φ}^{″} = ∠ OQP = {cos}^{- 1} \frac{L}{N} \qquad ( 4 )$$

Therefore, the angle of rotation φ of the rotation axis Q of the pickup arm 1b may be expressed as the following equations (5).

$$φ = {φ}^{′} + {φ}^{″} = π - θ - {cos}^{- 1} \frac{{M}^{2} + {N}^{2} - {r}^{2}}{2 M N} + {cos}^{- 1} \frac{L}{N} \qquad ( 5 )$$

By transforming the equations (5), the angle of rotation θ of the rotation shaft S of the control arm 1a may be expressed by the following equation (6).

$$θ = π - φ - {cos}^{- 1} \frac{{M}^{2} + {N}^{2} - {r}^{2}}{2 M N} + {cos}^{- 1} \frac{L}{N} \qquad ( 6 )$$

It can be understood from the equation (1) that N=line segment OQ is a function of the radius R of the groove of the record 4. It can be understood from the equations (2) and the equations (5) that the angle of rotation θ of the control arm 1a and the angle of rotation φ of the pickup arm 1b are also functions of the radius R of the groove of the record 4. Since the relationship between R and θ, the relationship between R and φ, and the relationship between θ and φ may be approximated by using secondary expressions, they may be obtained easily.

The control arm 1a of the tone arm 1 is rotated around the rotation shaft S, so that the pickup arm 1b is disposed with its longitudinal axis (extending in the direction of the line segment PQ) is in the tangent direction of the groove of the record 4 by means of the joint mechanism 1c for the pickup arm 1b. The length of the pickup arm 1b is always the same.

Therefore, the stylus 5 may be moved in the tangent direction of the groove of the record 4 if the angle of rotation (the angle between the control arm 1a and the pickup arm 1b) φ of the pickup arm 1b and the angle of rotation θ of the control arm 1a are appropriate angles calculated by the equations (1) to (6).

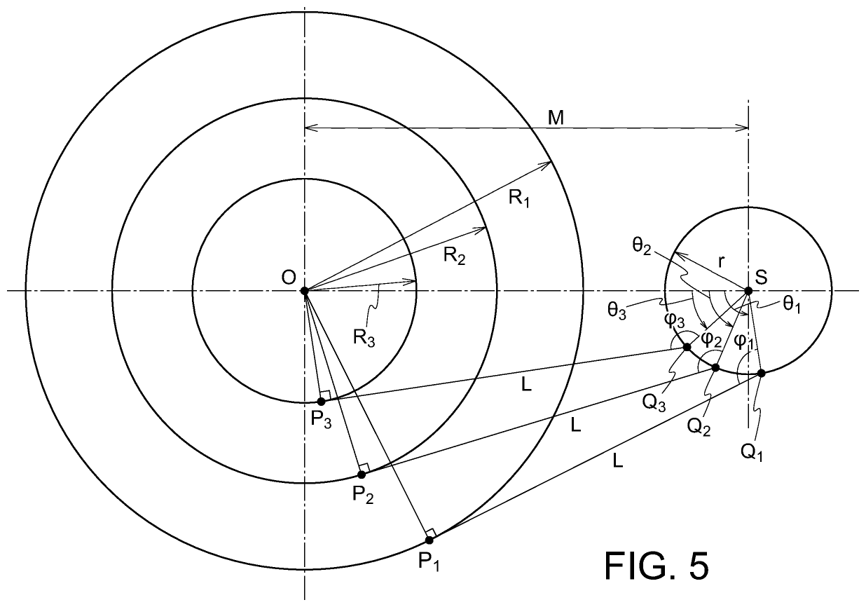

FIG. 5 is a diagram showing changes in angle of rotation φ of the pickup arm 1b when the angle of rotation θ of the control arm 1a is changed in various ways. FIG. 5 shows the positional relationship between the control arm 1a and the pickup arm 1b at a play start position of the record 4, an intermediate playing position of the record 4, and a play end position of the record 4. In FIG. 5, when the angle of rotation of the control arm 1a is θ₁, θ₂, and θ₃, which correspond to the play start position, the intermediate playing position, and the play end position of the record 4, respectively, the angle of rotation of the pickup arm 1b is shown as φ₁, φ₂, and φ₃, the radius of the groove of the record 4 is shown as R₁, R₂, and R₃, the contact position of the stylus 5 and the groove of the record 4 is shown as P₁, P₂, and P₃, and the rotation center of the pickup arm 1b is shown as Q₁, Q₂, and Q₃, respectively.

When the record 4 is played, first the stylus 5 of the phono cartridge 6 is brought into contact with a point P₁ in the groove around the periphery of the record 4. At this time, in order to cause the longitudinal axis of the pickup arm 1b (in the direction of the line segment PQ) to match the tangent direction of the groove of the record 4, the rotation axis of the pickup arm 1b needs to be located at a point Q1. The angle of rotation of the rotation shaft of the control arm 1a is θ₁, and the angle of rotation of the rotation axis of the pickup arm 1b (the angle between the control arm 1a and the pickup arm 1b) is φ₁.

When the stylus 5 reaches a point in the groove at the intermediate playing position of the record that is being played, the angle of rotation of the rotation shaft of the control arm 1a is θ₂, and the angle of rotation at the rotation axis of the pickup arm 1b is φ₂. When the stylus 5 reaches a point in the groove at the play end position of the record 4 that is being played, the angle of rotation of the rotation shaft of the control arm 1a is θ₃, and the angle of rotation at the rotation axis of the pickup arm 1b is φ₃.

As may be understood from FIG. 5, as the play of the record 4 continues, the angle of rotation of the rotation shaft of the control arm 1a changes like θ₁-θ₂-θ₃, and the angle between the control arm 1a and the pickup arm 1b changes like φ₁-φ₂-φ₃. The angle of rotation of the rotation shaft of the control arm 1a decreases like θ₁>θ₂>θ₃, and the angle between the control arm 1a and the pickup arm 1b increases like φ₁<φ₂<φ₃.

Thus, as the play of the record 4 continues, the angle of rotation of the control arm 1a gradually decreases while the angle between the control arm 1a and the pickup arm 1b gradually increases. The controller 14 controls the angle of rotation θ of the rotation shaft of the control arm 1a so that the longitudinal axis of the pickup arm 1b (in the direction of the line segment PQ) always matches the tangent direction of the groove of the record 4 while the record 4 is being played. More specifically, the controller 14 causes the rotary encoder to always detect the angle of rotation θ of the rotation shaft of the control arm 1a and the angle φ between the control arm 1a and the pickup arm 1b, in order to control the angle of rotation θ of the rotation shaft of the control arm 1a to meet the equations (5) and (6).

As described above, the equations (5) and (6) may be easily calculated by setting the design parameters such as the length r of the control arm 1a, the length L of the pickup arm 1b, and the distance M between the rotation center O of the turn table 3 and the rotation shaft S of the control arm 1a.

In the example shown in FIG. 4, the control arm 1a and the pickup arm 1b of the tone arm 1 are arranged so that the line segment OS connecting the rotation center O of the turn table 3 and the rotation shaft S of the control arm 1a does not cross the pickup arm 1b. However, the control arm 1a and the pickup arm 1b may be arranged so that the line segment OS crosses the pickup arm 1b.

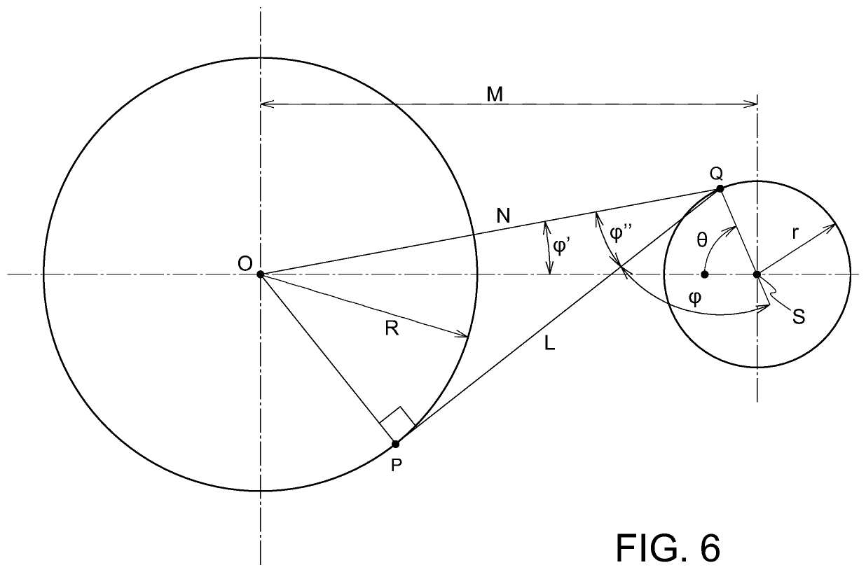

FIG. 6 is a diagram showing a geometric arrangement of the tone arm 1 when the control arm 1a and the pickup arm 1b are arranged so that the line segment OS crosses the pickup arm 1b. In the tone arm 1 shown in FIG. 6, a line segment connecting the rotation center O of the turn table 3 and the rotation shaft S of the control arm 1a crosses the control arm 1a. The equations (1) and (2) described above also hold in the case of FIG. 6.

The angle φ′=∠QOS may be expressed by the equations (7), and the angle φ″=∠OQP may be expressed by the equations (8).

$${φ}^{′} = ∠ QOS = {cos}^{- 1} \frac{{M}^{2} + {N}^{2} - {r}^{2}}{2 M N} \qquad ( 7 )$$

$${φ}^{″} = ∠ OQP = {cos}^{- 1} \frac{L}{N} \qquad ( 8 )$$

With respect to ΔQOS, the equations (9) hold.

$$φ = π - θ - {φ}^{′} - {φ}^{″} = π - θ - {cos}^{- 1} \frac{{M}^{2} + {N}^{2} - {r}^{2}}{2 M N} - {cos}^{- 1} \frac{L}{N} \qquad ( 9 )$$

By transforming the equations (9), the angle of rotation θ of the rotation shaft S of the control arm 1a may be expressed by the following equation (10).

$$θ = π - φ - {cos}^{- 1} \frac{{M}^{2} + {N}^{2} - {r}^{2}}{2 M N} - {cos}^{- 1} \frac{L}{N} \qquad ( 10 )$$

It may be understood from the equation (1) that N=line segment OQ is a function of the radius R of the groove of the record 4. It may be understood from the equations (2) and the equation (10) that the angle of rotation θ of the control arm 1a and the angle of rotation φ of the pickup arm 1b are also functions of the radius R of the groove of the record 4. Since the relationship between R and θ, the relationship between R and φ, and the relationship between θ and φ may be approximated by using secondary expressions, they may be obtained easily.

Also in the tone arm 1 shown in FIG. 6, the controller 14 controls the angle of rotation of the rotation shaft of the control arm 1a so that the longitudinal axis of the pickup arm 1b is in the tangent direction of the groove of the record 4. More specifically, the controller 14 controls the angle of rotation θ of the rotation shaft of the control arm 1a and the angle φ between the control arm 1a and the pickup arm 1b so as to always meet the equations (9) and (10).

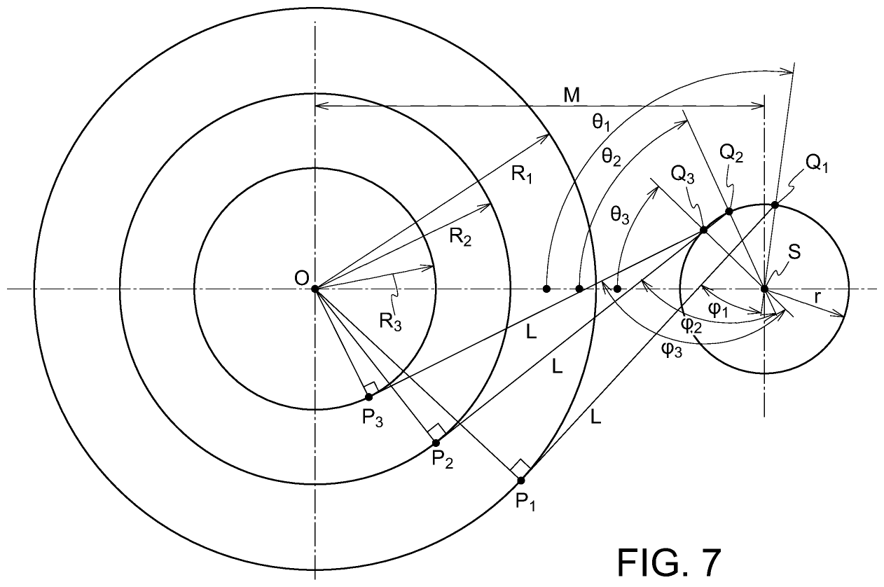

FIG. 7 is a diagram showing changes in angle of rotation φ of the pickup arm 1b when the angle of rotation θ of the control arm 1a is changed in various ways. FIG. 7 shows the positional relationship between the control arm 1a and the pickup arm 1b at a play start position of the record 4, an intermediate playing position of the record 4, and a play end position of the record 4. In FIG. 7, when the angle of rotation of the control arm 1a is θ₁, θ₂, and θ₃, which correspond to the play start position, the intermediate playing position, and the play end position of the record 4, respectively, the angle of rotation of the pickup arm 1b is shown as φ₁, φ₂, and φ₃, the radius of the groove of the record 4 is shown as R₁, R₂, and R₃, the contact position of the stylus 5 and the groove of the record 4 is shown as P₁, P₂, and P₃, and the rotation center of the pickup arm 1b is shown as Q₁, Q₂, and Q₃.

As may be understood from FIG. 7, as the play of the record 4 continues, the angle of rotation of the rotation shaft of the control arm 1a changes like θ₁-θ₂-θ₃, and the angle between the control arm 1a and the pickup arm 1b changes like φ₁-φ₂-φ₃. The angle of rotation of the rotation shaft of the control arm 1a decreases like θ₁>θ₂>θ₃, and the angle between the control arm 1a and the pickup arm 1b increases like φ₁<φ₂<φ₃.

Like the tone arm 1 shown in FIG. 5, as the play of the record 4 continues, the angle of rotation of the control arm 1a gradually decreases while the angle between the control arm 1a and the pickup arm 1b gradually increases. The controller 14 controls the angle of rotation θ of the rotation shaft of the control arm 1a so that the longitudinal axis of the pickup arm 1b (in the direction of the line segment PQ) always matches the tangent direction of the groove of the record 4 while the record 4 is being played. More specifically, the controller 14 causes the rotary encoder to always detect the angle of rotation θ of the rotation shaft of the control arm 1a and the angle φ between the control arm 1a and the pickup arm 1b, in order to control the angle of rotation θ of the rotation shaft of the control arm 1a to meet the equations (9) and (10).

As described above, the tone arm 1 according to the embodiment includes the control arm 1a that rotates around the rotation shaft, and the pickup arm 1b that rotates around the free fulcrum Q of the control arm 1a. The angle of rotation of the rotation shaft of the control arm 1a is controlled so that, when the stylus 5 attached to the pickup arm 1b is brought into contact with the groove of the record 4 while the record 4 is being rotated, the longitudinal axis of the pickup arm 1b is always in the tangent direction of the groove of the record 4. As the angle of rotation of the rotation shaft of the control arm 1a is controlled, the angle between the control arm 1a and the pickup arm 1b is also changed so that the angle of rotation θ of the rotation shaft of the control arm 1a and the angle φ between the control arm 1a and the pickup arm 1b are controlled to meet either the equations (5) and (6) or the equations (9) and (10). As a result, no tracking angle error or inside force may be caused.

The aspects of the disclosure are not limited to the above-described embodiment, and may have a variety of other forms embodied by those skilled in the art. Furthermore, the effects of the disclosure are not limited to those described above. Thus, various additions, changes, and partial omissions may be made without departing from the conceptual spirit of the disclosure derived from the accompanying claims and their equivalents.

1. A tone arm comprising:
a first arm configured to rotate around a rotation shaft in a horizontal direction of a record;
a second arm configured to rotate around a free fulcrum of the first arm as the first arm rotates;
a motor configured to rotatably drive the first arm; and
a controller configured to control a phase angle of the motor so that the second arm is disposed with a longitudinal axis thereof extends in a tangent direction of a groove of the record at a contact position of a stylus attached to a tip portion of the second arm and the groove of the record.

2. The tone arm according to claim 1, wherein the second arm includes a joint mechanism rotatably attached to the free fulcrum, the joint mechanism rotating in accordance with a rotation of the first arm and a movement of the stylus along the groove of the record.

3. The tone arm according to claim 1, wherein the controller is configured to control the phase angle of the motor so that a direction of a line segment connecting the contact position of the second arm and the free fulcrum is in parallel to the tangent direction of the groove while the record is being played.

4. The tone arm according to claim 1, wherein the controller is configured to control the phase angle of the motor so that no inside force or tracking angle error is generated at the contact position.

5. The tone arm according to claim 1, further comprising:
a first angle detector configured to detect an angle of rotation of the first arm; and
a second angle detector configured to detect an angle of rotation of the second arm,
wherein the controller is configured to control the angle of rotation of the first arm by controlling the phase angle of the motor so that the longitudinal axis of the second arm is in the tangent direction of the groove at the contact position based on the angle of rotation of the first arm detected by the first angle detector and the angle of rotation of the second arm detected by the second angle detector.

6. The tone arm according to claim 5, wherein the controller is configured to control the phase angle of the motor so that the angle of rotation of the second arm detected by the second angle detector matches an angle of rotation calculated based on the angle of rotation of the first arm detected by the first angle detector, a distance from a rotation center of the turn table for rotating the record to the rotation shaft of the first arm, a distance from the rotation center of the turn table to the free fulcrum, a length of the first arm, and a length of the second arm.

7. The tone arm according to claim 1, wherein the first arm and the second arm are disposed so that a line segment connecting the contact position and the free fulcrum does not cross a line segment connecting a rotation center of the turn table and the rotation shaft of the first arm.

8. The tone arm according to claim 1, wherein the first arm and the second arm are disposed so that a line segment connecting the contact position and the free fulcrum crosses a line segment connecting a rotation center of the turn table and the rotation shaft of the first arm.

9. A record player comprising:
a turn table configured to rotate a record; and
a tone arm configured to cause a stylus to be in contact with a groove of the record rotating on the turn table,
wherein the tone arm includes:
a first arm configured to rotate around a rotation shaft in a horizontal direction of the record;
a second arm configured to rotate around a free fulcrum of the first arm as the first arm rotates;
a stylus that is attached to a tip portion of the second arm and in contact with a groove of the record;
a motor configured to rotatably drive the first arm; and
a controller configured to control a phase angle of the motor so that the second arm is disposed with a longitudinal axis thereof extending in a tangent direction of the groove of the record at a contact position of the stylus and the groove of the record while the record is being played.
